(19) United States
(12) Patent Application Publication
(10) Pub. No.: US 2024/0235595 A1
(43) Pub. Date: Jul. 11, 2024

(54) RECEIVER SIDE DYNAMIC WINDOW OVERLAP AND ADD PROCEDURE

(71) Applicant: Intel Corporation, Santa Clara, CA (US)

(72) Inventors: Peter PAWLIUK, Tempe, AZ (US); Gregory CHANCE, Chandler, AZ (US)

(21) Appl. No.: 18/477,566

(22) Filed: Sep. 29, 2023

Related U.S. Application Data
(60) Provisional application No. 63/476,956, filed on Dec. 23, 2022.

(51) Int. Cl. H04B 1/10

(52) U.S. Cl. CPC H04B 1/1027

(57) ABSTRACT

A radio frequency front end device includes an antenna interface, configured to receive a signal representing a radio transmission; a radio frequency detector, wherein the signal includes a first signal in a first frequency range and a second signal in a second frequency range, adjacent to the first frequency range, and wherein the radio frequency detector is configured to detect the second signal within the second frequency range; and a processor, configured to select, based on the second signal, a sampling window size for a sampling window of a signal windowing procedure for the first signal in the first frequency range; and implement the signal windowing procedure on the first signal at the sampling window size.

### CROSS-REFERENCE TO RELATED APPLICATIONS

This non-provisional application claims priority to U.S. provisional application 63/476,956, filed on Dec. 23, 2022, the entire contents of which are incorporated herein by reference.

### TECHNICAL FIELD

Various aspects of this disclosure generally relate to the filtering of a received wireless signal using a dynamically-controlled window overlap and add procedure.

### BACKGROUND

In a 5G base-station (BS) or user equipment (UE) device, blocking signals can interfere with the reception of a desired signal. Channel filters (e.g. digital channel filters) may be conventionally used to eliminate or otherwise reduce the effect of blocking signals on a desired signal so that a received signal may be relatively free of blocking signals when the Fast Fourier Transform (FFT) is performed. Such filters can be very long (e.g. FIR filters of >100 taps), and consume significant power and area on the chip. They may also introduce ripple in-band, which degrades the signal quality of the wanted signal.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 depicts a symbol of an exemplary wireless transmission according to a cyclic-prefix orthogonal frequency division multiplexing (CP-OFDM) protocol;

FIG. 2 depicts a window overlap and add procedure (WOLA) with a windowing function;

FIG. 3 depicts a cellular receiver block diagram, with a dynamic WOLA based on narrowband blocker detection;

FIG. 4 depicts a simulated performance of WOLA with different window lengths;

FIG. 5 depicts an alternative configuration of a cellular receiver block diagram with dynamic WOLA based on narrowband blocker detection;

FIG. 6 depicts a radio frequency front end device; and

FIG. 7 depicts a method of signal processing.

### DETAILED DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A window overlap and add (WOLA) procedure can be employed in the receiver, after the channel filter and before the FFT. The WOLA greatly reduces the interference caused by blocking signals, which permits the size of the channel filter (e.g. the digital channel filter) to be significantly reduced, thereby reducing the required power and the corresponding computational resources. The WOLA procedure, however, may also increase inter-symbol interference (ISI). This ISI can be mitigated by applying the WOLA only when close-in blockers (e.g. blocking signals that are close in frequency to the frequencies of the desired frequency band) are detected and/or by varying the size of the corresponding window. By measuring the blocker power and/or frequency offset and/or delay spread, an optimized length of the WOLA window may be determined, such as for each symbol.

As described above, a conventional approach to filtering blocking signals is to use a large, fixed filter. Nevertheless, using a large filter is inefficient in terms of computational complexity, and therefore also its power and area. Moreover, such channel filters are relatively inflexible, as they cannot be dynamically adapted, such as on a per symbol basis. Although WOLA may be conventionally used for such channel filtering purposes, WOLA is conventionally used in a fixed format, in which the window size remains constant. Although this fixed WOLA is more efficient than filtering, it leads to increased ISI, which limits the ability of the receiver to handle multipath fading conditions.

As described herein, a dynamic WOLA can be used in a cellular receiver to improve receiver's resilience against blocking signals. The length of the window can be modulated (e.g. increased or decreased in size), such as based on the measured strength and frequency-offset of the blocking signal. This optimizes the blocking performance while mitigating ISI, where possible. This strategy greatly improves the resilience against blocking signals and permits the use of a much smaller channel filter, which saves power and area on the transceiver. Also, this reduction in filter size directly reduces the latency of the receiver. The principles and methods disclosed herein include the measurement of incoming signals, and using these measurements to actively reconfiguring the WOLA window size.

FIG. 1 depicts a symbol of a wireless transmission according to a cyclic-prefix orthogonal frequency division multiplexing (CP-OFDM) protocol. As with conventional orthogonal frequency division multiplexing, CP-OFDM divides transmissions into carrier frequencies, and the transmissions on adjacent carrier frequencies are orthogonal to each other, so as to minimize or prevent interference from adjacent carriers. In CP-OFDM, the symbol includes a cyclic prefix, which is the end of the symbol that is appended to the beginning of the symbol. This is depicted in at least FIG. 1, in which a symbol includes symbol data 102, and an end portion 104 of the symbol data is appended to the beginning of the symbol as a cyclic prefix 106. In this manner, the symbol becomes periodic. This addition of the cyclic prefix helps to reduce multipath fading. At the receiver, samples for the FFT are typically chosen from the center of the Symbol+CP to have the largest separation from adjacent symbols and to avoid inter-symbol interference (ISI). In WOLA, however, and instead of taking a rectangular window of samples for the FFT, wherein the rectangular window has a length corresponding to the number of bits in the symbol (e.g. the number of bits without the cyclic prefix), a larger span of samples is selected and a windowing function (e.g. a raised cosine function) is applied to the larger sample. Since the samples repeat cyclically, the samples at the start and the end of the window can be overlapped and thus added together. This reduces the sample size back to the FFT length and restores the signal level.

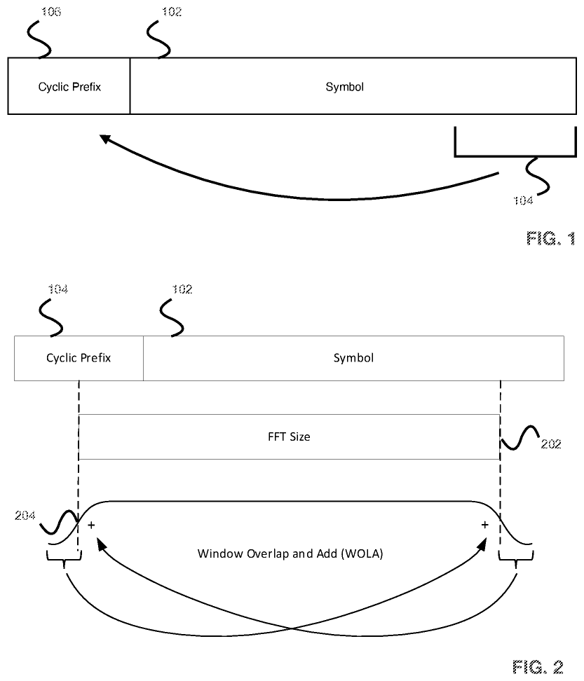

FIG. 2 depicts a WOLA procedure with a windowing function. In this figure, the symbol data 102 and the cyclic prefix 104 are as depicted in FIG. 1. The FFT data 202 depicts the length that must be sampled so that the complete set of data is accounted for in the FFT. The window length 204, however, is longer than the FFT size 202. This extended window length is subjected to a windowing function, which may exemplarily be a raised cosine function. The result of this windowing function is the tapered edges of the window length 204. These tapered edges may be wrapped and added back into the FFT data 202, as depicted by the arrows in FIG. 2. The windowing function is selected to be complementary. That is, after the edge samples (e.g. the samples corresponding to the edges of the windowing function) are wrapped around as depicted in FIG. 2, the total gain throughout the window is unity.

For blocking signals adjacent to the desired signal, the raised cosine windowing function helps to contain the spectrum so that it does not interfere as much with the adjacent spectrum. That is the WOLA procedure improves isolation of the blocking signal such that it does not as greatly affect other nearby frequencies. The result is a greatly improved sensitivity of the receiver in the presence of blockers.

The disadvantage is that the larger span of samples included in the window increases the likelihood of inter-symbol interference (ISI). To remedy the problems associated with ISI, the WOLA may be applied dynamically. In this manner, detected blocker signals may be used to determine the length of the WOLA window. If the blocker is stronger or closer-in, then the window is extended wider. If the blocker is weaker or further out, then the window size is reduced. Using this dynamic adjustment, the device and methods disclosed herein may optimize the ISI and blocker resilience of the receiver.

Returning to the subject of the cyclic prefix, the cyclic prefix is designed to provide a buffer to compensate for delay spread in the channel, so the WOLA window length may also be limited by the amount of delay spread in the channel. It should be noted however, that the alternative approach of increasing the size of the FIR channel filter will also cause ISI, and therefore the dynamic WOLA adjustment disclosed herein allows for an optimized solution that addresses both degradation due to blockers and ISI/delay spread. The window length can also be based on the modem's estimate of delay spread; alternatively or additionally, metrics such as signal to noise ratio (SNR) can be utilized to in the control of the window length to optimize the benefits of the windowing for blocker rejection vs. any degradation from picking up ISI due to delay spread.

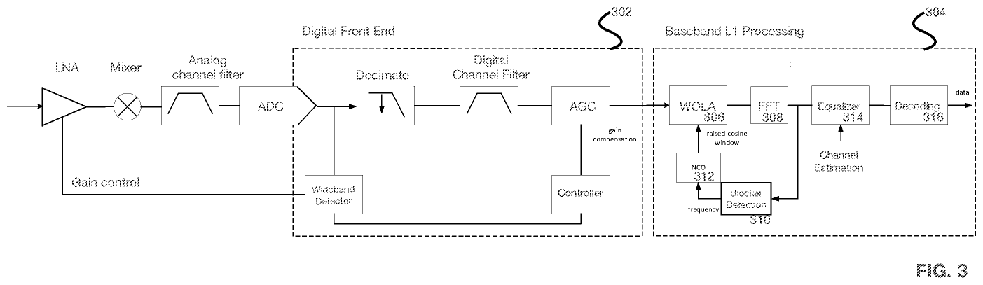

FIG. 3 depicts a cellular receiver block diagram, with a dynamic WOLA based on narrowband blocker detection. In this figure, a received signal is first conventionally processed in the low noise amplifier (LNA) and in a subsequent mixer; thereafter, it is subject to an analog channel filter and then is digitized at the analog digital converter (ADC), at which point, it enters the digital front end 302. Within the digital front end 302, the signal may undergo a decimation (or downsampling; see “Decimate” in FIG. 3) and a digital channel filter, and automatic gain control (AGC), at which point the signal enters the baseband L1 processing 304.

In the baseband L1 processing 304, the signal undergoes the WOLA 306 procedure, and the resulting signal is then sent to the FFT 308 for transformation into the frequency domain. Of note, the blocker detector 310 may analyze the resulting signal in the frequency domain for blocker signals (see “blocker detection” 310). Based on the frequency and/or power of the detected blocking signal, a suitable WOLA window is chosen. The raised cosine window is generated at the numeric controlled oscillator (NCO) 312, and this raised cosine window is used to perform the WOLA step at 306. As is apparent in FIG. 3, this process includes a feedback loop, which can be taken advantage of to dynamically select a WOLA size. Following the FFT 308, the signal in the frequency domain is sent to the equalizer 314, where channel estimation is performed. The resulting signal is then decoded 316.

Of course, not all blocking signals require WOLA. Before the WOLA procedure is performed, the signal undergoes filtering, which is generally able to remove blocker signals whose frequencies are sufficiently far from the desired signal. Only blockers that are close-in (e.g. their frequencies are close to that of the desired signal) will not be filtered out by the preprocessing RF filter and decimation filters, and thus require WOLA.

The easiest way to detect these close-in blocker signal that require WOLA is to use the sidebands of the FFT output. In 5G New Radio, for example, the FFT size is usually chosen to be a power of 2 so that it can be calculated efficiently. However, not all of the frequency bins are allocated to subcarriers in the channel. The leftover sidebands of the FFT would contain any close-in blocking signals, thereby providing an indication of their strength and frequency. The length of the WOLA can then be controlled by how strong and close-in the blocker is. These window length updates can occur rapidly, on a per-symbol basis. Unlike changing the channel filter in real-time, changing the window length in real-time does not disturb the channel estimation.

In one configuration, the window length may be conveniently modified between symbols using an NCO. By changing the NCO frequency, the raised cosine shape can be generated with different lengths.

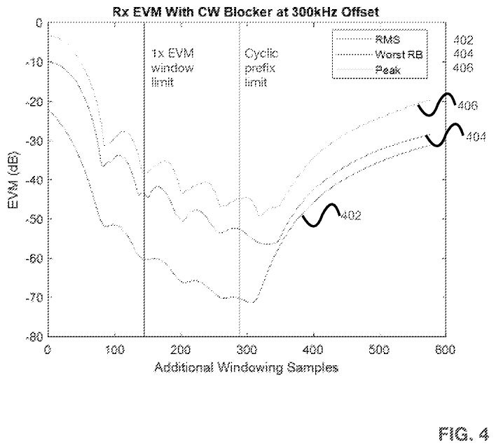

The procedures disclosed herein were simulated using a blocker as a continuous wave tone that was 300 kHz away from a 50 MHz NR signal (e.g. the desired signal). FIG. 4 depicts a simulated performance of WOLA with different window lengths, according to the simulation. The blocker was 6 dB stronger than the desired signal. The number of additional samples used for the windowing is plotted in the x-axis. The results are plotted as root mean square (RMS) 402, worst resource block (RB) 404, and peak 406. When the additional samples are 0, the system has no WOLA. Once the additional samples exceeds the cyclic prefix length, then the windowing extends into adjacent symbols, which causes ISI. However, even with only 72 additional samples, an improvement of 30 dB was achieved for EVM.

At a 300 kHz offset, it would be difficult to design a channel filter that provides enough rejection. Typically, such FIR filters would require 100+ taps. With WOLA procedure as described herein, however, significant improvements in performance can be achieved with an approximate computational complexity of only a single tap.

According to one exemplary implementation, the bottom of the first dip in the EVM response can be selected to optimize the choice of window length. This ensures a strong blocking performance with a minimum window size. The relationship between the blocker frequency and the additional windowing samples at this optimization point is:

$$\\ {S}_{add} = \frac{1.3 {f}_{s}}{{f}_{block}}$$

Where fₛ is the WOLA sampling rate, f_{block} is the blocker frequency offset relative to the signal edge, and S_{add} is the number of additional samples for windowing.

In an additional simulation in which the WOLA was dynamically changed in the middle of a slot, it was confirmed that such dynamic changing does not disturb the reception. Upon activating the WOLA, an immediate improvement in the EVM and in the bit error rate (BER) was seen, even though the channel estimation was performed earlier on the DMRS symbol.

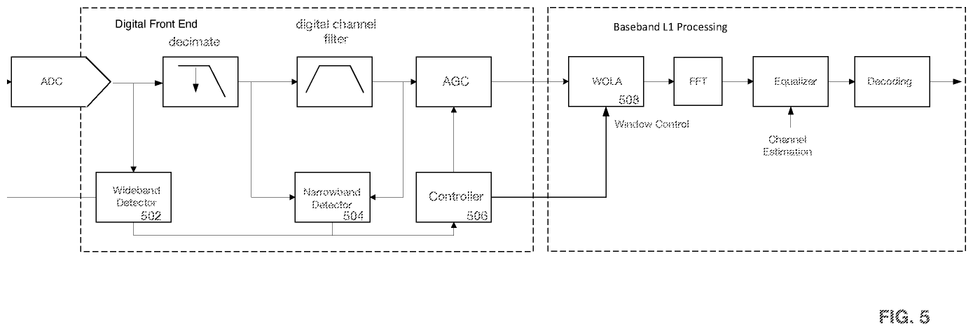

FIG. 5 depicts an alternative configuration of a cellular receiver block diagram with dynamic WOLA based on narrowband blocker detection. In this figure, the preprocessing steps prior to the ADC have been omitted so that the remaining elements exhibit greater legibility; however, the preprocessing steps before the ADC are identical to those in FIG. 3. In FIG. 5, the wideband detector 502 and the narrowband detector 504 output to a controller 506, which determines the WOLA window size that is used by the WOLA 508. Otherwise stated, by using an additional narrowband power detector that measures power at the baseband sampling rate, it can be determined whether there are close-in blockers. By comparing the power before and after the digital channel filter, it can be estimated how close-in the blocker is by comparing the rejection provided by the channel filter to the known channel filter response. This works well for blockers that are stronger than the wanted signal power, which is a focus for WOLA.

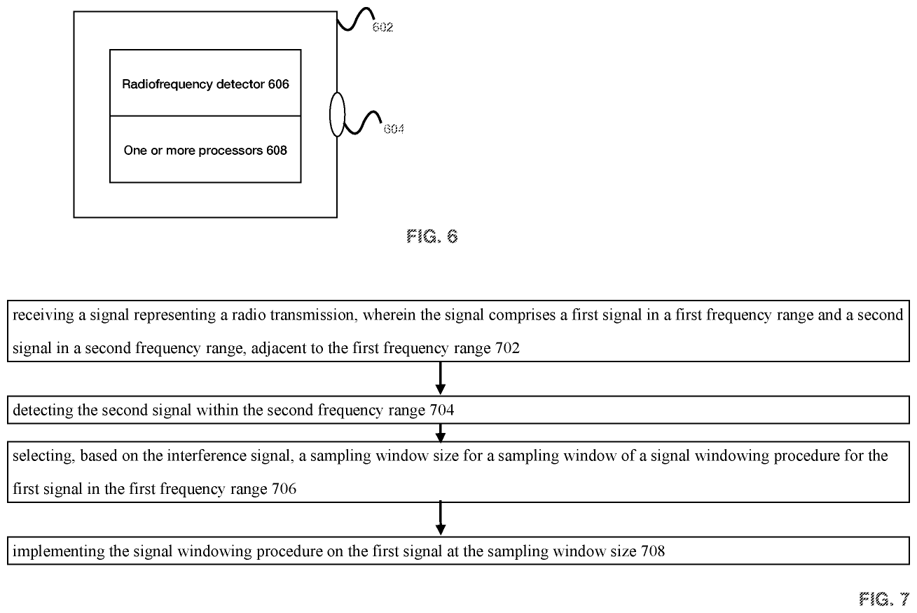

FIG. 6 depicts a radio frequency front end device 602, including an antenna interface 604, configured to receive a signal representing a radio transmission; a radio frequency detector 606; wherein the signal includes a first signal in a first frequency range and a second signal in a second frequency range, adjacent to the first frequency range, and wherein the radio frequency detector is configured to detect the second signal within the second frequency range; and a processor 608, configured to select, based on the second signal, a sampling window size for a sampling window of a signal windowing procedure for the first signal in the first frequency range; and implement the signal windowing procedure on the first signal at the sampling window size.

The signal windowing procedure may be an overlap and add procedure, such as in which a window is extended beyond the FFT length and subjected to a windowing function (e.g. a raised cosine function). In this manner, performing the overlap and add procedure may include the processor extracting an end portion of the sampling window and adding it to a beginning portion of the sampling window, and extracting a beginning portion of the sampling window and adding it to an end portion of the sampling window. The interference signal may be the blocker signal as described herein.

In one optional implementation, the processor selecting the sampling window size for the signal windowing procedure may include the processor selecting the sampling window size based on a proximity of the second signal to the first frequency range (e.g. a proximity of a frequency of the blocking signal to the first frequency range). In this manner, selecting the sampling window size for the signal windowing procedure may include selecting a larger sampling window when the second frequency is closer to the first frequency range and selecting a smaller sampling window when the second frequency is farther from the first frequency range. Alternatively or additionally, the processor selecting the sampling window size for the signal windowing procedure may include selecting the sampling window size based on a detected power level of the second frequency. Alternatively or additionally, selecting the sampling window size for the signal windowing procedure may include the processor selecting a larger sampling window when the second frequency has a greater power and selecting a smaller sampling window when the second frequency has less power.

In an optional configuration, the one or more processors may be further configured to estimate a delay spread of the radio transmission. The delay spread is a measure of the multipath richness of the communication channel. Measuring the delay spread may include measuring a difference in the time of arrival between a first component of the multipath transmission and a last component of the multipath transmission (e.g. a difference in time between when a symbol or part of a symbol first arrives and when that symbol and part of the symbol last arrives). In this manner, the processor selecting the sampling window size for the signal windowing procedure may include selecting the sampling window size based on the estimated delay spread. In this manner, selecting the sampling window size for the signal windowing procedure may include selecting a larger sampling window when the estimated delay spread is larger and selecting a smaller sampling window when the estimated delay spread is smaller.

If the radio frequency detector detects no interference signal in the second frequency range, adjacent to the first frequency range, the one or more processors may be further configured to discontinue using the signal windowing procedure.

The radio frequency detector may be configured as a narrowband detector.

The antenna interface may be any kind of antenna interface, configured to connect to an antenna. In certain implementations, the radio frequency detector may include its own antenna, and in other implementations, the radio frequency detector may include only an antenna interface, which may be connected to one or more antennas.

The radio frequency detector may be configured to receive a signal, such as a signal received at one or more antennas and then received by the radio frequency detector from the one or more antennas via the antenna interface. The signal may include or represent a first signal in a first frequency range and a second signal in a second frequency range, adjacent to the first frequency range. The first frequency range may be understood as the desired frequency range or the frequency range in which the desired signal is sent or expected to be received. The second frequency range may be understood as a frequency range that is adjacent to the first frequency range, and in which one or more interference signals or blocker signals (these may be used interchangeably for the purposes of this disclosure) are present. In this manner, the second signal as disclosed herein is a blocker signal or an interference signal. This second signal (e.g. this blocker signal or interference signal) may be any signal in the second frequency range that may negatively affect the FFT and/or decoding of the received first signal. This may be, for example, by virtue of the second signal's power and/or its proximity to the first frequency range. The radio frequency detector may be configured to detect the second signal within the second frequency range.

It is expressly noted that the radio frequency detector may be implemented in whole or in part in a processor. This processor, may be the same processor that is otherwise descried as the processor herein, or a different processor altogether. That is, a processor that implements part or all of the radio frequency detector as disclosed herein may optionally be the same processor that selects, based on the second signal, a sampling window size for a sampling window of a signal windowing procedure for the first signal in the first frequency range, and implements the signal windowing procedure on the first signal at the sampling window size.

References to the signal windowing procedure herein may be understood as the window overlap and add procedure.

The processor may select (e.g. dynamically select) the sampling window size for the signal windowing procedure. In this manner, the processor may select the sampling window size based on a proximity of a frequency of the second signal to the first frequency range. That is, the processor may select a larger sampling window when the second signal is closer to the first frequency range and may select a smaller sampling window when the second signal is farther from the first frequency range. The relationship between distance from the first frequency range and window size may therefore be inverse (the greater the distance, the smaller the size). The relationship may be linearly inverse, exponentially inverse, or any other configuration. The skilled person may select the specific relationship between frequency distance and window size for a given parameter based on the particular implementation.

Alternatively or additionally, wherein the processor selecting the sampling window size for the signal windowing procedure may include the processor selecting the sampling window size based on a detected power level of the second signal. In this manner, the processor may be configured to select a larger sampling window when the second signal has a greater power and to select a smaller sampling window when the second signal has less power. As with the selection based on the frequency distance, above, the skilled person may select the specific window size for a given second signal strength based on the particular implementation. Otherwise stated, although the specific window size for a specific second signal strength may vary depending on the particular implementation, the window sizes may generally be selected such that larger blocking signal powers result in larger sampling windows and smaller second signal powers result in smaller sampling windows.

The sampling window may be selected relative to the FFT length. That is, when the sampling window is equal to the FFT length, then no WOLA is applied. When the sampling window is greater than the FFT length, then WOLA is applied. The length of the WOLA may be any length greater than or equal to the FFT length (although a sampling window equal to the FFT represents no WOLA); however, larger sampling windows (e.g. greater than the length of the cyclic prefix) may be associated with greater ISI.

FIG. 7 depicts a method of signal processing. The method includes receiving a signal representing a radio transmission, wherein the signal includes a first signal in a first frequency range and a second signal in a second frequency range, adjacent to the first frequency range 702; detecting the second signal within the second frequency range 704; selecting, based on the interference signal, a sampling window size for a sampling window of a signal windowing procedure for the first signal in the first frequency range 706; and implementing the signal windowing procedure on the first signal at the sampling window size 708.

The following optional example demonstrates an optional example of how the skilled person may apply the receiver-side dynamic WOLA to an NR base-station (BS). In this example, a channel with a 50 MHz bandwidth (BW) and 30 kHz subcarrier spacing (SCS), operating in band n48 (3550-3700 MHz) is used. In this case, the FFT size is 2048 samples; the short cyclic prefix length is 144 samples; and the long cyclic prefix length is 176 samples.

Continuing in this example, the system will set the windowing size according to the power level and frequency of a nearby blocker. The power level and frequency are estimated by measuring the FFT bins adjacent to the allocated channel. If no blocking signals are detected, the window size is set to the minimum 2048 samples. The largest window size that is effective would be the FFT size plus the short cyclic prefix length 2048+144=2192. As shown at least with respect to FIG. 4, above, a larger window size would begin to degrade performance by introducing ISI. The window size will saturate to this largest size in the case of extreme blocker power and close-in frequency location. For other blockers, the frequency offset of the blocker from the allocated channel f_{block} and the sampling rate at the FFT fₛ=61.44 MHz may be used to calculate an optimal minimum number of additional windowing samples S_{add}^{f} as:

$$\\ {S}_{add}^{{}_{} f} = 1.3 \frac{{f}_{s}}{{f}_{block}}$$

In addition to this basic frequency optimization, the window may be extended by S_{add}^{p} additional samples based on the power of the blocker and the modulation order M. A look-up table, such as the one reproduced below, may be used to find the appropriate amount of additional samples based on the factor V that depends on the blocker power and modulation order. The factor V may be be rounded to the nearest LUT index.

$V = \frac{\sqrt{M}}{100} 10 {log}_{10} ( \frac{{p}_{block}}{{p}_{sub}} )$

| V | S_{add}^{p} |
|---|---|
| 0 | 0 |
| 1 | 10 |
| 2 | 20 |
| 3 | 30 |
| 4 | 40 |
| 5 | 50 |
| 6 | 65 |
| 7 | 80 |
| 8 | 100 |
| 9 | 120 |
| 10 | 140 |

Here, the power of the blocker p_{block} is compared to the power of an average subcarrier from the wanted signal p_{sub}. In this case, the modulation order will change dynamically between M=2 BPSK, M=4 QPSK, M=16 16-QAM, M=64, 64-QAM, and M=256 256-QAM. More samples will be added for higher modulation orders because the signal quality requirements for demodulation will be more stringent. If multiple UEs are operating with different modulation orders, then the UE with a resource block (RB) allocation closest to the blocker is ideally considered.

If there are multiple blockers, the blocker that requires the most additional samples may be chosen to calculate S_{add}^{f}+S_{add}^{p}. The total window length may be calculated dynamically for each signal as follows.

$$\\ {S}_{total} = min ( 2192 , 2048 + {S}_{add}^{{}_{} f} + {S}_{add}^{{}_{} p} )$$

The value Sₜₒₜₐₗ may be rounded to the nearest even integer to maintain symmetry around the timing center.

In an example scenario, a blocker approaches with an offset of 1.4 MHz from the wanted signal. The blocker power p_{block} is −30 dBFS. The wanted signal is currently operating in 64QAM and is set to −18 dBFS at full-RBs. The power per subcarrier p_{sub} is then −50 dBFS. Therefore, it can be calculated that S_{add}^{f}=57.05 and S_{add}^{p}=1.6, and the total window size is Sₜₒₜₐₗ=2106.

Further aspects of the disclosure will be described by way of example:
In Example 1, a radio frequency front end device, including: an antenna interface, configured to receive a signal representing a radio transmission; a radio frequency detector, wherein the signal includes a first signal in a first frequency range and a second signal in a second frequency range, adjacent to the first frequency range, and wherein the radio frequency detector is configured to detect the second signal within the second frequency range; and a processor, configured to: select, based on the second signal, a sampling window size for a sampling window of a signal windowing procedure for the first signal in the first frequency range; and implement the signal windowing procedure on the first signal at the sampling window size.
In Example 2, the device of claim 1, wherein the signal windowing procedure is an overlap and add procedure.
In Example 3, the device of claim 2, wherein the processor implementing the signal windowing procedure includes the processor extracting an end portion of the sampling window and adding it to a beginning portion of the sampling window, and extracting a beginning portion of the sampling window and adding it to an end portion of the sampling window.
In Example 4, the device of any one of claims 1 to 3, wherein the second signal is a blocker signal.
In Example 5, the device of any one of claims 1 to 4, wherein the processor performing the signal windowing procedure includes the processor performing a raised cosine operation on the first signal.
In Example 6, the device of any one of claims 1 to 5, wherein the processor selecting the sampling window size for the signal windowing procedure includes the processor selecting the sampling window size based on a proximity of a frequency of the second signal to the first frequency range.
In Example 7, the device of claim 6, wherein the processor selecting the sampling window size for the signal windowing procedure includes the processor selecting a larger sampling window when the second signal is closer to the first frequency range and selecting a smaller sampling window when the second signal is farther from the first frequency range.
In Example 8, the device of any one of claims 1 to 7, wherein the processor selecting the sampling window size for the signal windowing procedure includes the processor selecting the sampling window size based on a detected power level of the second signal.
In Example 9, the device of claim 8, wherein the processor selecting the sampling window size for the signal windowing procedure includes the processor selecting a larger sampling window when the second signal has a greater power and selecting a smaller sampling window when the second signal has less power.
In Example 10, the device of any one of claims 1 to 9, wherein the processor is further configured to estimate a delay spread of the radio transmission; wherein the processor selecting the sampling window size for the signal windowing procedure includes selecting the sampling window size based on the estimated delay spread.
In Example 11, the device of claim 10, wherein the processor selecting the sampling window size for the signal windowing procedure includes the processor selecting a larger sampling window when the estimated delay spread is larger and selecting a smaller sampling window when the estimated delay spread is smaller.
In Example 12, the device of any one of claims 1 to 11, wherein if the a radio frequency detector detects no second signal in the second frequency range, the processor is further configured to discontinue using the signal windowing procedure.
In Example 13, the device of any one of claims 1 to 12, wherein the radio frequency detector is configured as a narrowband detector.
In Example 14, a method of signal processing, including: receiving a signal representing a radio transmission, wherein the signal includes a first signal in a first frequency range and a second signal in a second frequency range, adjacent to the first frequency range; detecting the second signal within the second frequency range; selecting, based on the interference signal, a sampling window size for a sampling window of a signal windowing procedure for the first signal in the first frequency range; and implementing the signal windowing procedure on the first signal at the sampling window size.
In Example 15, the method of claim 14, wherein the signal windowing procedure is an overlap and add procedure.
In Example 16, the method of claim 15, wherein implementing the signal windowing procedure includes extracting an end portion of the sampling window and adding it to a beginning portion of the sampling window, and extracting a beginning portion of the sampling window and adding it to an end portion of the sampling window.
In Example 17, the method of any one of claims 14 to 16, wherein the second signal is a blocker signal.
In Example 18, the method of any one of claims 14 to 17, wherein performing the signal windowing procedure includes performing a raised cosine operation on the first signal.
In Example 19, the method of any one of claims 14 to 18, wherein selecting the sampling window size for the signal windowing procedure includes selecting the sampling window size based on a proximity of a frequency of the second signal to the first frequency range.
In Example 20, the method of claim 19, wherein selecting the sampling window size for the signal windowing procedure includes selecting a larger sampling window when the second signal is closer to the first frequency range and selecting a smaller sampling window when the second signal is farther from the first frequency range.
In Example 21, the method of any one of claims 14 to 20, wherein selecting the sampling window size for the signal windowing procedure includes selecting the sampling window size based on a detected power level of the second signal.
In Example 22, the method of claim 21, wherein selecting the sampling window size for the signal windowing procedure includes selecting a larger sampling window when the second signal has a greater power and selecting a smaller sampling window when the second signal has less power.
In Example 23, the method of any one of claims 14 to 22, further including estimating a delay spread of the radio transmission; wherein selecting the sampling window size for the signal windowing procedure includes selecting the sampling window size based on the estimated delay spread.
In Example 24, the device of claim 23, wherein selecting the sampling window size for the signal windowing procedure includes selecting a larger sampling window when the estimated delay spread is larger and selecting a smaller sampling window when the estimated delay spread is smaller.
In Example 25, the device of any one of claims 14 to 24, further including discontinuing using the signal windowing procedure when the a radio frequency detector detects no second signal in the second frequency range.
In Example 26, the device of any one of claims 14 to 25, wherein the radio frequency detector is configured as a narrowband detector.
In Example 27, a non-transitory computer readable medium, including instructions which, if executed by one or more processors, are configured to cause the one or more processor to: receive a signal representing a radio transmission, including a first signal in a first frequency range and a second signal in a second frequency range, adjacent to the first frequency range; detect the second signal within the second frequency range; select, based on the second signal, a sampling window size for a sampling window of a signal windowing procedure for the first signal in the first frequency range; and implement the signal windowing procedure on the first signal at the sampling window size.
In Example 28, the non-transitory computer readable medium of claim 27, wherein the signal windowing procedure is an overlap and add procedure.
In Example 29, the non-transitory computer readable medium of claim 28, wherein the implementing the signal windowing procedure includes extracting an end portion of the sampling window and adding it to a beginning portion of the sampling window, and extracting a beginning portion of the sampling window and adding it to an end portion of the sampling window.
In Example 30, the non-transitory computer readable medium of any one of claims 27 to 29, wherein the second signal is a blocker signal.
In Example 31, the non-transitory computer readable medium of any one of claims 27 to 30, wherein performing the signal windowing procedure includes performing a raised cosine operation on the first signal.
In Example 32, the non-transitory computer readable medium of any one of claims 27 to 31, wherein selecting the sampling window size for the signal windowing procedure includes selecting the sampling window size based on a proximity of a frequency of the second signal to the first frequency range.
In Example 33, the non-transitory computer readable medium of claim 32, wherein selecting the sampling window size for the signal windowing procedure includes selecting a larger sampling window when the second signal is closer to the first frequency range and selecting a smaller sampling window when the second signal is farther from the first frequency range.
In Example 34, the non-transitory computer readable medium of any one of claims 27 to 33, wherein selecting the sampling window size for the signal windowing procedure includes selecting the sampling window size based on a detected power level of the second signal.
In Example 35, the non-transitory computer readable medium of claim 34, wherein selecting the sampling window size for the signal windowing procedure includes selecting a larger sampling window when the second signal has a greater power and selecting a smaller sampling window when the second signal has less power.
In Example 36, the non-transitory computer readable medium of any one of claims 27 to 35, wherein the instructions are further configured to cause the one or more processors to estimate a delay spread of the radio transmission; wherein selecting the sampling window size for the signal windowing procedure includes selecting the sampling window size based on the estimated delay spread.
In Example 37, the non-transitory computer readable medium of claim 36, wherein selecting the sampling window size for the signal windowing procedure includes selecting a larger sampling window when the estimated delay spread is larger and selecting a smaller sampling window when the estimated delay spread is smaller.
In Example 38, the non-transitory computer readable medium of any one of claims 27 to 37, wherein if no second signal in the second frequency range is detected, the instructions are further configured to cause the one or more processors to discontinue using the signal windowing procedure.
In Example 39, the non-transitory computer readable medium of any one of claims 27 to 38, wherein the radio frequency detector is configured as a narrowband detector.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A radio frequency front end device, comprising:
an antenna interface, configured to receive a signal representing a radio transmission;
a radio frequency detector, wherein the signal comprises a first signal in a first frequency range and a second signal in a second frequency range, adjacent to the first frequency range, and wherein the radio frequency detector is configured to detect the second signal within the second frequency range; and
a processor, configured to:
select, based on the second signal, a sampling window size for a sampling window of a signal windowing procedure for the first signal in the first frequency range; and
implement the signal windowing procedure on the first signal at the sampling window size.

2. The device of claim 1, wherein the signal windowing procedure comprises the processor extracting an end portion of the sampling window and adding the extracted end portion to a beginning portion of the sampling window, and extracting a beginning portion of the sampling window and adding the extracted beginning portion to an end portion of the sampling window.

3. The device of claim 1, wherein the second signal is a blocker signal.

4. The device of claim 1, wherein the processor performing the signal windowing procedure comprises the processor multiplying the first signal with a window shaped as a raised cosine.

5. The device of claim 1, wherein the processor selecting the sampling window size for the signal windowing procedure comprises the processor selecting the sampling window size based on a proximity of a frequency of the second signal to the first frequency range.

6. The device of claim 5, wherein the processor selecting the sampling window size for the signal windowing procedure comprises the processor selecting a larger sampling window when the second signal is closer to the first frequency range and selecting a smaller sampling window when the second signal is farther from the first frequency range.

7. The device of claim 1, wherein the processor selecting the sampling window size for the signal windowing procedure comprises the processor selecting the sampling window size based on a detected power level of the second signal.

8. The device of claim 7, wherein the processor selecting the sampling window size for the signal windowing procedure comprises the processor selecting a larger sampling window when the second signal has a greater power and selecting a smaller sampling window when the second signal has less power.

9. The device of claim 1, wherein the processor is further configured to estimate a delay spread of the radio transmission; wherein the processor selecting the sampling window size for the signal windowing procedure comprises selecting the sampling window size based on the estimated delay spread.

10. The device of claim 9, wherein the processor selecting the sampling window size for the signal windowing procedure comprises the processor selecting a larger sampling window when the estimated delay spread is larger and selecting a smaller sampling window when the estimated delay spread is smaller.

11. The device of claim 1, wherein if the a radio frequency detector detects no second signal in the second frequency range, the processor is further configured to discontinue using the signal windowing procedure.

12. The device of claim 1, wherein the radio frequency detector is configured as a narrowband detector.

13. A non-transitory computer readable medium, comprising instructions which, if executed by one or more processors, are configured to cause the one or more processor to:
receive a signal representing a radio transmission, comprising a first signal in a first frequency range and a second signal in a second frequency range, adjacent to the first frequency range;
detect the second signal within the second frequency range;
select, based on the second signal, a sampling window size for a sampling window of a signal windowing procedure for the first signal in the first frequency range; and
implement the signal windowing procedure on the first signal at the sampling window size.

14. The non-transitory computer readable medium of claim 13, wherein the signal windowing procedure is an overlap and add procedure.

15. The non-transitory computer readable medium of claim 13, wherein the processor selecting the sampling window size for the signal windowing procedure comprises the processor selecting the sampling window size based on a proximity of a frequency of the second signal to the first frequency range by selecting a larger sampling window when the second signal is closer to the first frequency range and selecting a smaller sampling window when the second signal is farther from the first frequency range.

16. The non-transitory computer readable medium of claim 13, wherein the processor selecting the sampling window size for the signal windowing procedure comprises the processor selecting the sampling window size based on a detected power level of the second signal by selecting a larger sampling window when the second signal has a greater power and by selecting a smaller sampling window when the second signal has less power.

17. A method of signal processing, comprising:
receiving a signal representing a radio transmission, wherein the signal comprises a first signal in a first frequency range and a second signal in a second frequency range, adjacent to the first frequency range;
detecting the second signal within the second frequency range;
selecting, based on the interference signal, a sampling window size for a sampling window of a signal windowing procedure for the first signal in the first frequency range; and
implementing the signal windowing procedure on the first signal at the sampling window size.

18. The method of claim 17,
wherein the processor selecting the sampling window size for the signal windowing procedure comprises the processor selecting the sampling window size based on a proximity of a frequency of the second signal to the first frequency range; wherein the processor is configured to select a larger sampling window when the second signal is closer to the first frequency range and to select a smaller sampling window when the second signal is farther from the first frequency range.

19. The non-transitory computer readable medium of claim 17, wherein the processor selecting the sampling window size for the signal windowing procedure comprises the processor selecting the sampling window size based on a detected power level of the second signal; wherein the processor is configured to select a larger sampling window when the second signal has a greater power and to select a smaller sampling window when the second signal has less power.

20. The non-transitory computer readable medium of claim 17, wherein the processor is further configured to estimate a delay spread of the radio transmission; wherein the processor is configured to
select a larger sampling window when the estimated delay spread is larger and select a smaller sampling window when the estimated delay spread is smaller.
